(19) United States
(12) Patent Application Publication
(10) Pub. No.: US 2021/0097368 A1
(43) Pub. Date: Apr. 1, 2021

(54) Data Processing System and Data Processing Method Thereof

(71) Applicant: NEUCHIPS CORPORATION, Hsinchu (TW)

(72) Inventors: Youn-Long Lin, Hsinchu City (TW); Chao-Yang Kao, Hsinchu City (TW); Huang-Chih Kuo, Kaohsiung City (TW)

(21) Appl. No.: 16/789,388

(22) Filed: Feb. 12, 2020

Related U.S. Application Data
(60) Provisional application No. 62/908,609, filed on Oct. 1, 2019.

(30) Foreign Application Priority Data
Nov. 15, 2019 (TW) 108141621

(51) Int. Cl. G06N 3/04; G06F 17/14; G06N 3/08

(52) U.S. Cl. CPC G06N 3/04; G06N 3/084; G06F 17/14

(57) ABSTRACT

A processing system includes at least one signal processing unit and at least one neural network layer. A first signal processing unit of the at least one signal processing unit performs signal processing with at least one first parameter. A first neural network layer of the at least one neural network layer has at least one second parameter. The at least one first parameter and the at least one second parameter are trained together.

### CROSS REFERENCE TO RELATED APPLICATIONS

This application claims the benefit of U.S. Provisional Application No. 62/908,609 filed on Oct. 1, 2019, which are incorporated herein by reference.

### BACKGROUND OF THE INVENTION

### 1. Field of the Invention

The present invention relates to a data processing system and a data processing method, and more particularly, to a data processing system and a data processing method able to optimize overall system as a whole, avoid wasting time and keep down labor costs.

### 2. Description of the Prior Art

In deep learning technology, a neural network may include collections of neurons, and may have a structure or function similar to a biological neural network. Neural networks can provide useful techniques for various applications, especially those related to digital signal processing such as image or audio data processing. These applications can be quite complicated if they are processed by conventional digital signal processing. For example, parameters of digital signal processing must be manually adjusted, which requires time and labor. Neural networks can be trained to build optimized neural networks with large amounts of data and automatic training, thereby beneficial to complex tasks or data processing.

### SUMMARY OF THE INVENTION

It is therefore an objective of the present invention to provide a data processing system and a data processing method able to optimize overall system as a whole, avoid wasting time and keep down labor costs.

The present invention discloses a data processing system. The data processing system includes at least one signal processing unit and at least one neural network layer. A first signal processing unit of the at least one signal processing unit performs signal processing with at least one first parameter. A first neural network layer of the at least one neural network layer has at least one second parameter, and the at least one first parameter and the at least one second parameter are trained jointly.

The present invention further discloses a data processing method for a data processing system. The data processing method includes determining at least one signal processing unit and at least one neural network layer of the data processing system, automatically adjusting at least one first parameter and at least one second parameter via an algorithm; and calculating an output of the data processing system according to the at least one first parameter and the at least one second parameter. A first signal processing unit of the at least one signal processing unit performs signal processing with at least one first parameter, and a first neural network layer of the at least one neural network layer has at least one second parameter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a portion of a neural network according to an embodiment of the present invention.

FIG. 2 to FIG. 4 are schematic diagrams of data processing systems according to embodiments of the present invention, respectively.

FIG. 5 is a flowchart of a data processing method according to an embodiment of the present invention.

FIG. 6 to FIG. 9 are schematic diagrams of data processing systems according to embodiments of the present invention, respectively.

### DETAILED DESCRIPTION

In the following description and claims, the terms “include” and “comprise” are used in an open-ended fashion, and thus should be interpreted to mean “include, but not limited to”. Use of ordinal terms such as “first” and “second” does not by itself connote any priority, precedence, or order of one element over another or the temporal order in which acts of a method are performed, but are used merely as labels to distinguish one element having a certain name from another element having the same name.

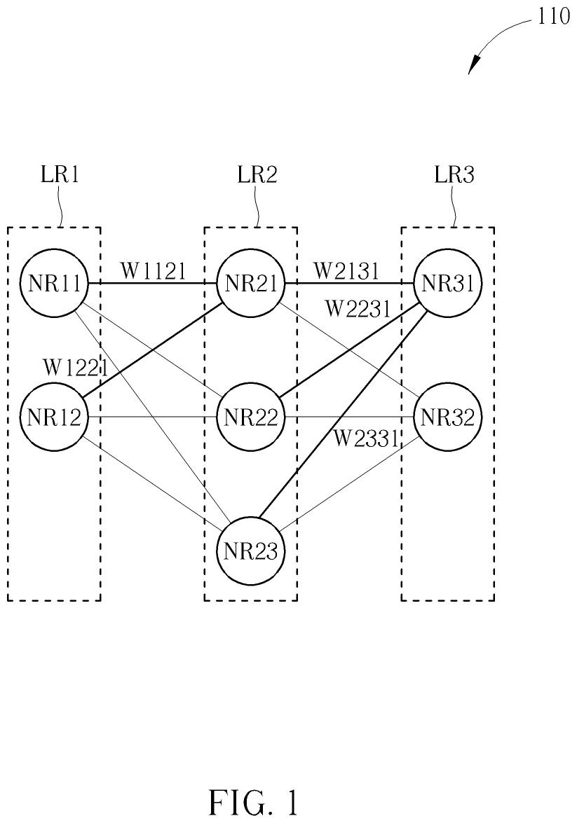

Please refer to FIG. 1, which is a schematic diagram of a portion of a neural network 110 according to an embodiment of the present invention. In some embodiments, the neural network 110 may be a computational unit or may represent a method to be executed by a computational unit. The neural network 110 includes neural network layers LR1-LR3. The neural network layers LR1-LR3 include neurons NR11-NR12, NR21-NR23 and NR31-NR32 respectively. The neurons NR11-NR12 receive data inputted to the neural network 110, and the neural network 110 outputs data via the neurons NR31-NR32. The neural network layers LR1-LR3 have at least one parameter (also referred to as second parameters) respectively. For example, W1121 represents a parameter for a connection from the neuron NR11 to the neuron NR21. In a broad sense, the neural network layer LR1 or the neural network layer LR2 has the parameter W1121. Similarly, W1221 represents a parameter for a connection from the neuron NR12 to the neuron NR21. W2131 represents a parameter for a connection from the neuron NR21 to the neuron NR31. W2231 represents a parameter for a connection from the neuron NR22 to the neuron NR31. W2331 represents a parameter for a connection from the neuron NR23 to the neuron NR31.

According to forward propagation, an input iNR21 of the neuron NR21 is equal to an output oNR11 of the neuron NR11 multiplied by the parameter W1121 plus an output oNR12 of the neuron NR12 multiplied by the parameter W1221, which is then transformed by an activation function F. That is, iNR21=F(oNR11*W1121+oNR12*W1221). An output oNR21 of the neuron NR21 is a function of the input iNR21. Similarly, an input iNR31 of the neuron NR31 is equal to an output oNR21 of the neuron NR21 multiplied by the parameter W2131 plus an output oNR22 of the neuron NR22 multiplied by the parameter W2231 and an output oNR23 of the neuron NR23 multiplied by the parameter W2331, which is then transformed by the activation function F. That is, iNR31=F(oNR21*W2131+oNR22*W2231+oNR23*W2331). An output oNR31 of the neuron NR31 is a function of the input iNR31. As is evident from the forgoing discussion, the output oNR31 of the neuron NR31 is a function of the parameters W1121-W2331.

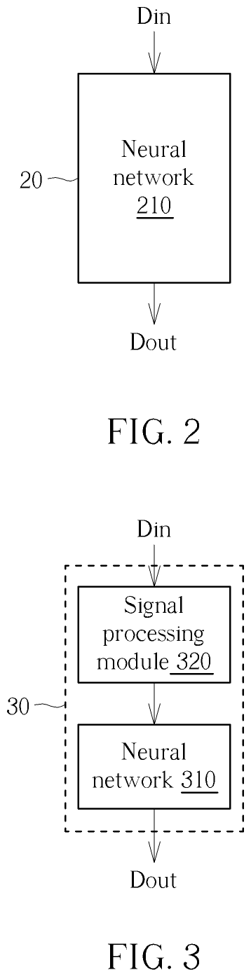

Please refer to FIG. 2, which is a schematic diagram of a data processing system 20 according to an embodiment of the present invention. The data processing system 20 receives an input Din, and sends an output Dout. The data processing system 20 includes a neural network 210, and the neural network 210 includes a plurality of neural network layers (for instance, the neural network layers LR1-LR3 shown in FIG. 1). Each neural network layer of the neural network 210 includes at least one neuron (for instance, the neurons NR11-NR32 shown in FIG. 1) respectively.

Please refer to FIG. 3, which is a schematic diagram of a data processing system 30 according to an embodiment of the present invention. Similar to the data processing system 20, the data processing system 30 includes a neural network 310, and the neural network 310 includes a plurality of neural network layers. Each neural network layer includes at least one neuron. Different from the data processing system 20, the data processing system 30 further includes a signal processing module 320. The signal processing module 320 provides functions of conventional digital signal processing as a portion of functions of the overall data processing system 30, and the neural network 310 provides functions of another portion of functions of the overall data processing system 30. The signal processing module 320 may be implemented as a processor, for example, a digital signal processor. That is, the data processing system 30 divides data processing into multiple tasks. Some of the tasks are processed by the neural network 310, and some of the tasks are processed by the signal processing module 320. However, dividing tasks requires manual intervention. In addition, once the parameters (that is to say, the values of the parameters) of the signal processing module 320 are determined manually, the neural network 310 would not change the parameters of the signal processing module 320 during a training process. The parameters of the signal processing module 320 must be manually adjusted, meaning that the parameters must be manually entered or adjusted, thereby consuming time and labor. Furthermore, the data processing system 30 may be optimized merely for each single stage but cannot be optimized for the overall system as a whole.

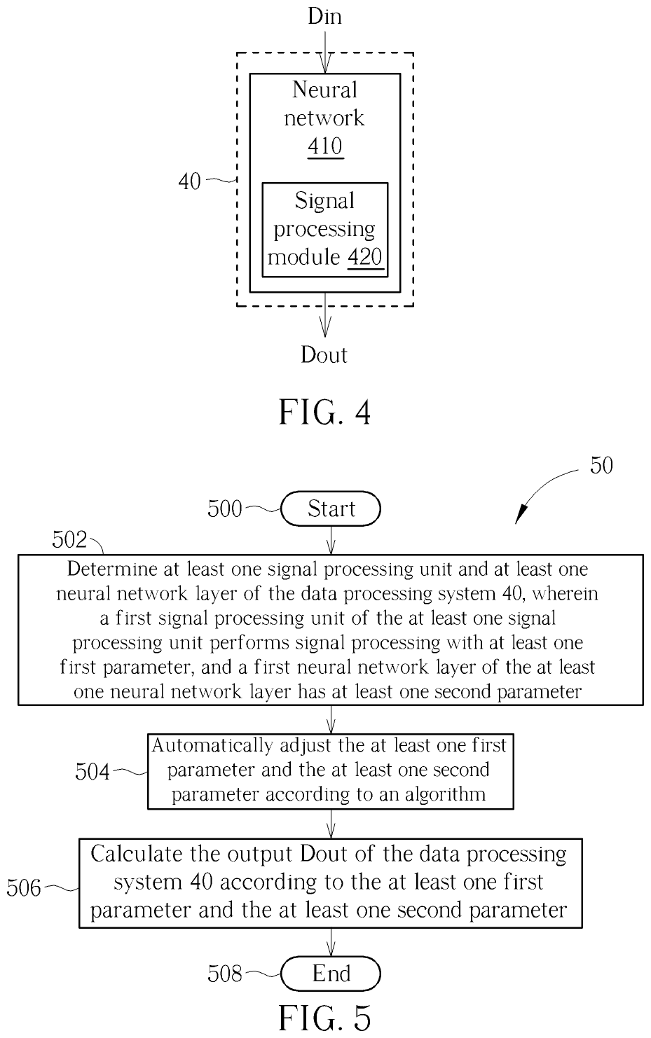

The signal processing algorithms (such as digital signal processing algorithms) utilized by a signal processing unit of the signal processing module 320 in FIG. 3 may provide some functions required by the data processing system 30. In order to accelerate overall system development and reduce the time and labor consumption, in some embodiments, a signal processing unit may be embedded in a neural network to form an overall data processing system. Please refer to FIG. 4, which is a schematic diagram of a data processing system 40 according to an embodiment of the present invention. The data processing system 40 includes a neural network 410 and a signal processing module 420. The neural network 410 includes at least one neural network layer (for example, the neural network layers LR1-LR3 shown in FIG. 1). Each neural network layer of the neural network 410 includes at least one neuron (for example, the neurons NR11-NR32 shown in FIG. 1). Each neural network layer has at least one parameter (also referred to as second parameters) (for example, the parameters W1121-W2331 shown in FIG. 1). The signal processing module 420 may include a plurality of signal processing units. A portion of the signal processing units in the signal processing module 420 may have at least one parameter (also referred to as first parameters), and may use the at least one parameter to perform signal processing. The signal processing module 420 is directly embedded in the neural network 410, so that data inputted into and outputted from the signal processing module 420 includes the parameters. The data processing system 40 adopts end-to-end learning to directly obtain and send an output Dout from an input Din received by the data processing system 40. All the parameters (such as the first parameters and the second parameters) are trained jointly, thereby optimizing the overall system as a whole and reducing time and labor consumption.

Briefly, by embedding the signal processing unit into the neural network 410, the parameters of the digital signal processing and the parameters of the neural network 410 may be trained jointly for optimization. As a result, the present invention avoids manual adjustment, and may optimize the overall system as a whole.

Specifically, the neural network layer may include, but is not limited to, Convolutional Neural Network (CNN), Recurrent Neural Network (RNN), Feedforward Neural Network (FNN), Long Short-Term Memory (LSTM) network, Gated Recurrent Unit (GRU), Attention Mechanism, Activation Function, Fully Connected Layer or pooling layer. Operation of the signal processing unit may include, but is not limited to, Fourier transform, cosine transform, inverse Fourier transform, inverse cosine transform, windowing, or Framing.

Furthermore, please refer to FIG. 5, which is a flowchart of a data processing method 50 according to an embodiment of the present invention. The data processing method 50 may be compiled into a code and executed by a processing circuit in the data processing system 40. The data processing method 50 includes following steps:

Step 500: Start.

Step 502: Determine at least one signal processing unit and at least one neural network layer of the data processing system 40, wherein a first signal processing unit of the at least one signal processing unit performs signal processing with at least one first parameter, and a first neural network layer of the at least one neural network layer has at least one second parameter.

Step 504: Automatically adjust the at least one first parameter and the at least one second parameter according to an algorithm.

Step 506: Calculate the output Dout of the data processing system 40 according to the at least one first parameter and the at least one second parameter.

Step 508: End.

In step 502, the present invention determines and configures connection manner, number, type, and number of parameters (such as the number of first parameters and the number of second parameters) of the at least one signal processing unit and the at least one neural network layer. In other words, deployment manner is determined and configured in step 502. Similar to the calculation method of the outputs oNR21 and oNR31, the output Dout of the data processing system 40 may be calculated according to forward propagation. In some embodiments, the algorithm of step 504 is Backpropagation (BP), and there is a total error between the output Dout of the data processing system 40 and a target. In step 504, all parameters (such as the first parameters and the second parameters) may be updated recursively by back propagation, such that the output Dout of the data processing system 40 gradually approaches the target value to minimize the total error. That is, back propagation may train all the parameters (such as the first parameters and the second parameters) and optimize all the parameters. For example, the parameter W1121 minus a learning rate r multiplied by partial differentiation of a total error Etotol with respect to the parameter W1121 may be utilized to obtain an updated parameter W1121′, which may be expressed as W1121′=W1121−r*∂Etotol/∂W1121. By recursively updating the parameter W1121, the parameter W1121 may be optimally adjusted. In step 506, according to all the optimized parameters (such as the first parameters and the second parameters), the data processing system 40 may perform inference and calculate the most correct output Dout from the input Din received by the data processing system 40.

As set forth above, all the parameters (such as the first parameter and the second parameter) may be trained jointly and optimized. In other words, all the parameters (such as the first parameter and the second parameter) are variable. All the parameters (such as the first and second parameters) may be gradually converged by means of algorithms (such as backpropagation). All the parameters (such as the first parameter and the second parameter) may be automatically determined and adjusted to the optimal values by means of algorithms (such as back propagation). Moreover, the output of the data processing system 40 is a function of all the parameters (for example, the first parameter and the second parameter), and is associated with all the parameters (for example, the first parameter and the second parameter). Similarly, the outputs of the signal processing units or the neural network layers are also associated with at least one parameter respectively.

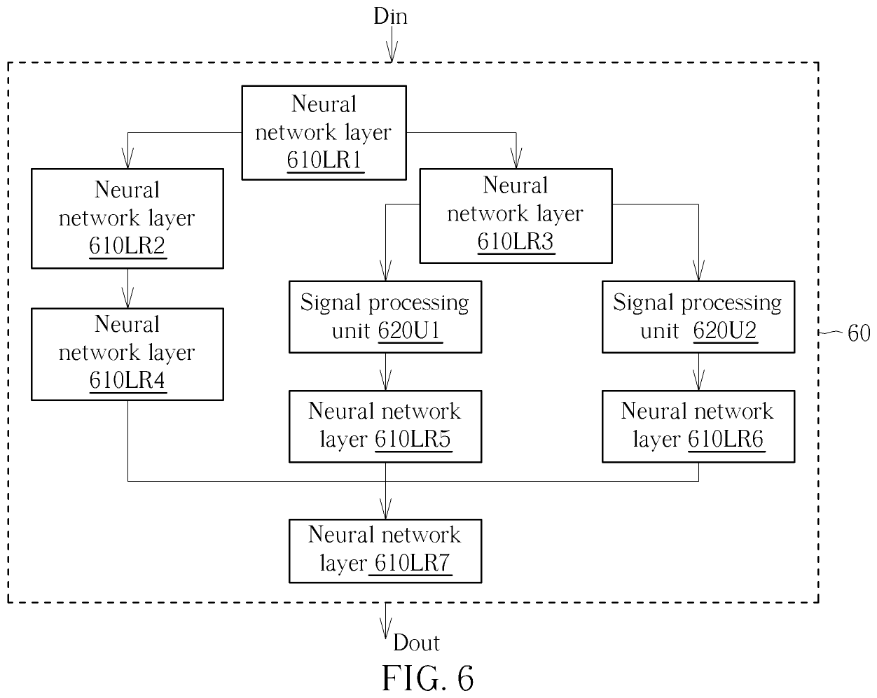

It is noteworthy that the data processing system 40 is an exemplary embodiment of the present invention, and those skilled in the art may make different alterations and modifications. For example, the deployment manner of a data processing system may be adjusted according to different design considerations. In some embodiments, a signal processing unit may receive data from a neural network layer or transmit data to a neural network layer. Furthermore, please refer to FIG. 6, which is a schematic diagram of a data processing system 60 according to an embodiment of the present invention. Similar to the data processing system 40, the data processing system 60 includes neural network layers 610LR1-610LR7 and signal processing units 620U1 and 620U2. Each of the neural network layers 610LR1-610LR7 includes at least one neuron (for example, the neurons NR11-NR32 shown in FIG. 1), and each has at least one parameter (also referred to as the second parameters) (for example, the parameters W1121-W2331 shown in FIG. 1). The signal processing units 620U1 and 620U2 may also have at least one parameter (also referred to as first parameters). The signal processing units 620U1 and 620U2 are directly embedded between the neural network layers 610LR1-610LR7, such that data inputted into and outputted from the signal processing units 620U1 and 620U2 includes the parameters. The data processing system 60 adopts end-to-end learning to directly obtain and send an output Dout from an input Din received by the data processing system 60. All the parameters (such as the first parameters and the second parameters) are trained jointly, thereby optimizing the overall system as a whole and reducing time and labor consumption.

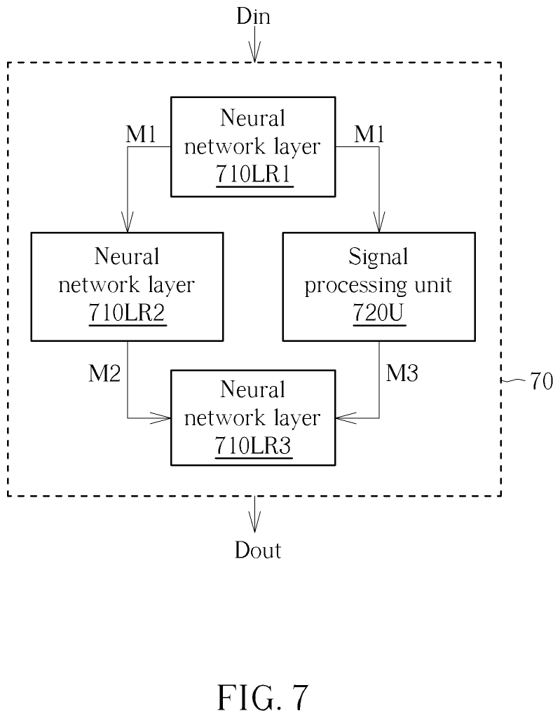

The deployment manner of the data processing system may be further adjusted. For example, please refer to FIG. 7, which is a schematic diagram of a data processing system 70 according to an embodiment of the present invention. Similar to the data processing system 60, the data processing system 70 includes neural network layers 710LR1-710LR3 and a signal processing unit 720U. Each of the neural network layers 710LR1-710LR3 includes at least one neuron, and each has at least one parameter (also referred to as second parameters). In some embodiments, the signal processing unit 720U (also referred to as a first signal processing unit) receives data M1, and the neural network layer 710LR2 (also referred to as a first neural network layer) also receives the data M1. In other embodiments, the signal processing unit 720U receives at least one first data, and the neural network layer 710LR2 receives at least one second data. A portion or all of the at least one first data are the same as a portion or all of the at least one second data. Data M3 (also referred to as a third data) outputted by the signal processing unit 720U is combined with data M2 (also referred to as a fourth data) outputted by the neural network layer 710LR2. A manner of combination includes, but is not limited to, concatenation or summation. The signal processing unit 720U may have at least one parameter (also referred to as first parameters). For example, the signal processing unit 720U may perform discrete cosine transform (DCT). A relation between the data M3 outputted by the signal processing unit 720U and the data M1 received by the signal processing unit 720U may be expressed as M3=DCT(M1*W1+b1)*W2+b2, where W1, W2, b1, and b2 are parameters of the signal processing unit 720U and are utilized to adjust the data Ml or a result of the discrete cosine transform. The output Dout of the data processing system 70 is a function of the parameters W1, W2, b1, and b2 and is associated with the parameters W1, W2, b1, and b2. That is, the signal processing unit 720U is directly embedded in the neural network, such that the data inputted into and outputted from the signal processing unit 720U includes the parameters. The data processing system 70 adopts end-to-end learning to directly obtain and send an output Dout from an input Din received by the data processing system 70. All the parameters (such as the first parameters and the second parameters) are trained jointly, thereby optimizing the overall system as a whole and reducing time and labor consumption.

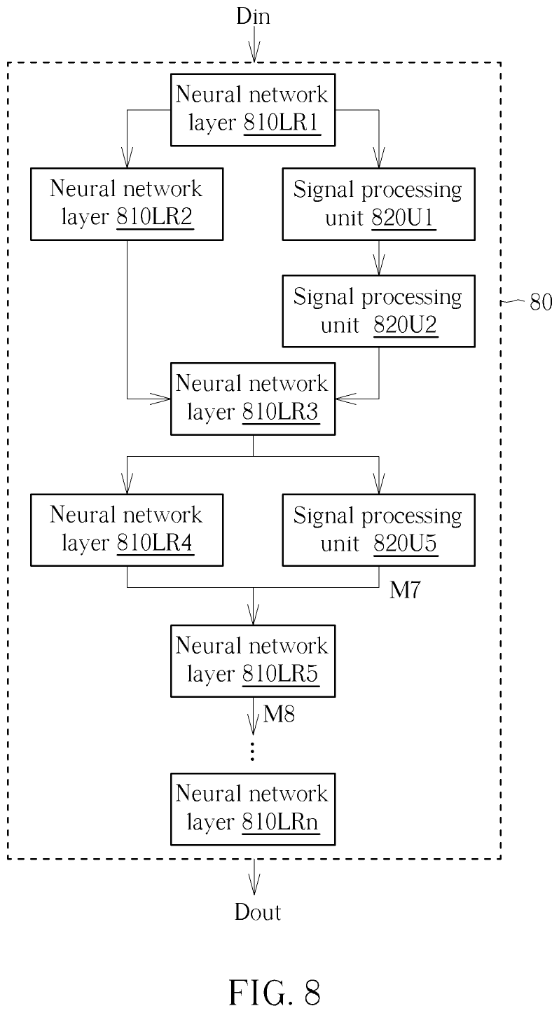

The deployment manner of the data processing system may be further adjusted. For example, please refer to FIG. 8, which is a schematic diagram of a data processing system 80 according to an embodiment of the present invention. Similar to the data processing system 60, the data processing system 80 includes neural network layers 810LR1-810LRn and signal processing units 820U1, 820U2, and 820U5. Each of the neural network layers 810LR1-810LRn includes at least one neuron, and each has at least one parameter (also referred to as second parameters). The signal processing units 820U1, 820U2, and 820U5 may have at least one parameter (also referred to as first parameters). The signal processing units 820U1, 820U2, and 820U5 are directly embedded between the neural network layers 810LR1-810LRn, such that the data inputted into and outputted from the signal processing units 820U1, 820U2, and 820U5 includes the parameters. The data processing system 80 adopts end-to-end learning to directly obtain and send an output Dout from an input Din received by the data processing system 80. All the parameters (such as the first parameters and the second parameters) are trained jointly, thereby optimizing the overall system as a whole and reducing time and labor consumption.

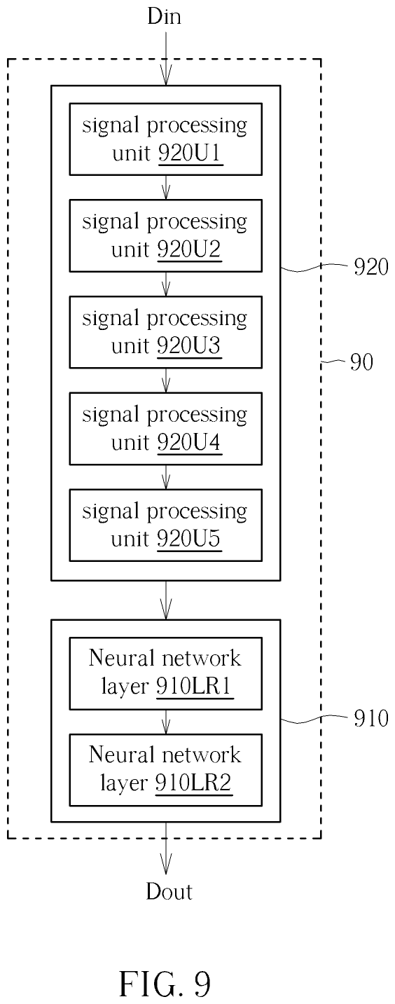

In contrast, please refer to FIG. 9, which is a schematic diagram of a data processing system 90 according to an embodiment of the present invention. The data processing system 90 includes a neural network 910 and a signal processing module 920. The neural network 910 includes a plurality of neural network layers 910LR1 and 910LR2. Each of the neural network layers 910LR1 and 910LR2 includes at least one neuron, and each has at least one parameter (also referred to as second parameters). The signal processing module 920 includes a plurality of signal processing units 920U1-920U5. The data processing system 90 divides data processing into multiple tasks. Some of the tasks are processed by the neural network 910, and some of the tasks are processed by the signal processing module 920. However, dividing tasks requires manual intervention. In addition, once the parameters (that is to say, the values of the parameters) of the signal processing units 920U1-920U5 are determined manually, the neural network 910 would not change the parameters of the signal processing units 920U1-920U5 during a training process. The parameters of the signal processing module 920 must be manually adjusted, meaning that the parameters must be manually entered or adjusted, thereby consuming time and labor. Furthermore, the data processing system 90 may be optimized merely for each single stage but cannot be optimized for the overall system as a whole.

For example, in some embodiments, the data processing system 80 of FIG. 8 and the data processing system 90 of FIG. 9 may be speech keyword recognition systems respectively. In some embodiments, the signal processing units 820U1 and 920U1 perform pre-emphasis respectively, and parameters (also referred to as first parameters) associated with the pre-emphasis include pre-emphasis coefficients. In the data processing system 90, parameters (such as the pre-emphasis coefficients) must be determined by means of manual intervention. In some embodiments, the pre-emphasis coefficient is set in a range of 0.9 to 1. In the data processing system 80, parameters (such as pre-emphasis coefficients) are determined without manual intervention, but the parameters (such as the pre-emphasis coefficients) in the data processing system 80 are instead trained jointly with other parameters for optimization. In some embodiments, the signal processing units 820U1 and 920U1 perform framing respectively, and parameters (also referred to as the first parameters) associated with framing include a frame size and a frame overlap ratio. In the data processing system 90, parameters (such as the frame size or the frame overlap ratio) must be determined by means of manual intervention. In some embodiments, the frame size is set in a range of 20 milliseconds (ms) to 40 milliseconds, and the frame overlap ratio is set in a range of 40% to 60%. In the data processing system 80, parameters (such as the frame size or the frame overlap ratio) are determined without manual intervention, but the parameters (such as the frame size or the frame overlap ratio) in the data processing system 80 are instead trained jointly with other parameters for optimization. In some embodiments, the signal processing units 820U1 and 920U1 perform windowing respectively, and parameters (also referred to as first parameters) associated with windowing may include cosine window coefficients. In the data processing system 90, the parameters (such as the cosine window coefficients) must be determined by means of manual intervention. In some embodiments, the cosine window coefficient is set to be 0.53836 to serve as Hamming Window, and the cosine window coefficient is set to be 0.5 to serve as Hanning Window. In the data processing system 80, parameters (such as the cosine window coefficients) are determined without manual intervention, but the parameters (such as the cosine window coefficients) in the data processing system 80 are instead trained jointly with other parameters for optimization.

In some embodiments, the signal processing units 820U5 and 920U5 perform an inverse discrete cosine transform (IDCT) respectively. Parameters (also referred to as first parameters) associated with the inverse discrete cosine transform may be inverse discrete cosine transform coefficients or the number of the inverse discrete cosine transform coefficients. The inverse discrete cosine transform coefficients may be utilized as Mel-Frequency Cepstral Coefficient (MFCC). In the data processing system 90, parameters (such as the number of the inverse discrete cosine transform coefficients) must be determined by means of manual intervention. In some embodiments, the number of the inverse discrete cosine transform coefficients may be in a range of 24 to 26. In other embodiments, the number of the inverse discrete cosine transform coefficients may be set to be 12. In the data processing system 80, parameters (such as the number of the inverse discrete cosine transform coefficients) are determined without manual intervention, but the parameters (such as the number of the inverse discrete cosine transform coefficients) in the data processing system 80 are instead trained jointly with other parameters for optimization. For example, the output M7 of the signal processing unit 820U5 is the inverse discrete cosine transform coefficients or a function of the inverse discrete cosine transform coefficients. After the neural network layer 810LR5 receives the output M7 of the signal processing unit 820U5, each inverse discrete cosine transform coefficient may be individually multiplied by one parameter (also referred to as the second parameter) of the neural network layer 810LR5. In some embodiments, if one of the plurality of second parameters of the neural network layer 810LR5 is zero, the inverse discrete cosine transform coefficient multiplied by this second parameter equal to zero would not be outputted from the neural network layer 810LR5. In other words, the output M8 of the neural network layer 810LR5 would not be a function of this inverse cosine transform coefficient. In this case, the first parameter (such as the number of inverse cosine transform coefficients) is automatically reduced without manual intervention.

To sum up, the signal processing unit is embedded in the neural network according to the present invention, such that the parameters of digital signal processing and the parameters of the neural network may be trained jointly. As a result, the present invention may optimize the overall system as a whole, avoid wasting time and keep down labor costs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing system, comprising:
at least one signal processing unit, wherein a first signal processing unit of the at least one signal processing unit performs signal processing with at least one first parameter;
and at least one neural network layer, wherein a first neural network layer of the at least one neural network layer has at least one second parameter, and the at least one first parameter and the at least one second parameter are trained jointly.

2. The data processing system of claim 1, wherein the at least one first parameter and the at least one second parameter are variable, and the at least one first parameter and the at least one second parameter are automatically adjusted according to an algorithm.

3. The data processing system of claim 1, wherein an output of the data processing system is a function of the at least one first parameter and the at least one second parameter, and is associated with the at least one first parameter and the at least one second parameter.

4. The data processing system of claim 1, wherein the first signal processing unit receives at least one first data, the first neural network layer receives at least one second data, and a portion or all of the at least one first data is a same as a portion or all of the at least one second data.

5. The data processing system of claim 1, wherein at least one third data outputted by the first signal processing unit and at least one fourth data outputted by the first neural network layer are combined, and a manner of combination comprises concatenation or summation.

6. The data processing system of claim 1, wherein the first signal processing unit receives at least one first data from the first neural network layer or transmits the at least one first data to the first neural network layer.

7. The data processing system of claim 1, wherein one of the at least one neural network layer comprises Convolutional Neural Network (CNN), Recurrent Neural Network (RNN), Feedforward Neural Network (FNN), Long Short-Term Memory (LSTM) Network, Gated Recurrent Unit (GRU), Attention Mechanism, Activation Function, fully-connected layer or pooling layer.

8. The data processing system of claim 1, wherein operation of the at least one signal processing unit comprises Fourier transform, cosine transform, inverse Fourier transform, inverse cosine transform, windowing or framing.

9. The data processing system of claim 1, wherein the at least one first parameter and the at least one second parameter are gradually converged by means of an algorithm.

10. A data processing method for a data processing system, comprising:
determining at least one signal processing unit and at least one neural network layer of the data processing system, wherein a first signal processing unit of the at least one signal processing unit performs signal processing with at least one first parameter, and a first neural network layer of the at least one neural network layer has at least one second parameter;
automatically adjusting the at least one first parameter and the at least one second parameter according to an algorithm; and
calculating an output of the data processing system according to the at least one first parameter and the at least one second parameter.

11. The data processing method of claim 10, wherein the at least one first parameter and the at least one second parameter are variable, the at least one first parameter and the at least one second parameter are trained jointly, and the algorithm is Backpropagation (BP).

12. The data processing method of claim 10, wherein the output of the data processing system is a function of the at least one first parameter and the at least one second parameter, and is associated with the at least one first parameter and the at least one second parameter.

13. The data processing method of claim 10, wherein the first signal processing unit receives at least one first data, the first neural network layer receives at least one second data, a portion or all of the at least one first data is a same as a portion or all of the at least one second data.

14. The data processing method of claim 10, wherein at least one third data outputted by the first signal processing unit and at least one fourth data outputted by the first neural network layer are combined, and a manner of combination comprises concatenation or summation.

15. The data processing method of claim 10, wherein the first signal processing unit receives at least one first data from the first neural network layer or transmits the at least one first data to the first neural network layer.

16. The data processing method of claim 10, wherein comprises Convolutional Neural Network (CNN), Recurrent Neural Network (RNN), Feedforward Neural Network (FNN), Long Short-Term Memory (LSTM) Network, Gated Recurrent Unit (GRU), Attention Mechanism, Activation Function, fully-connected layer or pooling layer.

17. The data processing method of claim 10, wherein operation of the at least one signal processing unit comprises Fourier transform, cosine transform, inverse Fourier transform, inverse cosine transform, windowing or framing.

18. The data processing method of claim 10, wherein the at least one first parameter and the at least one second parameter are gradually converged by means of the algorithm.
